(19) United States
(12) Patent Application Publication
(10) Pub. No.: US 2022/0070172 A1
(43) Pub. Date: Mar. 3, 2022

(54) METHODS AND SYSTEMS FOR ENABLING IDENTITY-BASED SERVICES USING A RANDOM IDENTIFIER

(71) Applicant: Comcast Cable Communications, LLC, Philadelphia, PA (US)

(72) Inventors: Saravanan Muthusamy, Philadelphia, PA (US); Prasad Siddalinga, Philadelphia, PA (US); Vinayaka Poovappa, Philadelphia, PA (US)

(21) Appl. No.: 17/465,084

(22) Filed: Sep. 2, 2021

Related U.S. Application Data
(60) Provisional application No. 63/073,845, filed on Sep. 2, 2020.

(51) Int. Cl. H04L 29/06; H04L 9/30; G06F 16/245

(52) U.S. Cl. CPC H04L 63/102; H04L 63/0876; H04W 12/40; G06F 16/245; H04L 9/30

(57) ABSTRACT

A network (e.g., Wi-Fi network, Internet, a private network, a public network, a content delivery network, cellular network, etc.) may be configured to uniquely identifying a user device (e.g., a mobile device, a smart device, a computer/computing device, a client device, etc.) using a random identifier (e.g., a random Media Access Control (MAC) address, etc.) and provide the user device identity-based services based on a secure transfer and identification of a persistent identifier (e.g., a MAC address, etc.) of the user device. The identity-based services may include: login-less network connection and/or reconnection, one or more subscription services, parental controls, content/advertisement tracking, private network access (e.g., identifier-based routing to private SSIDs, etc.), and/or the like.

### CROSS-REFERENCE TO RELATED APPLICATION

This application claims priority to U.S. Provisional Application No. 63/073,845, filed Sep. 2, 2020, the entirety of which is incorporated herein by reference.

### BACKGROUND

An identifier (e.g., a Media Access Control (MAC) address, an International Mobile Subscriber Identity (IMSI), an International Mobile Station Equipment Identity (IMEI), etc.) is used identify a user device (e.g., a mobile device, a smart device, a computer/computing device, a client device, etc.) to a network (e.g., a private network, a public network, Internet, etc.) and/or network device (e.g., an access point, a gateway, a Wi-Fi server, a captive portal device, etc.). The identifier may be persisted and/or stored by the network/network device to enable one or more identity-based services, such as a login-less network connection and/or reconnection, one or more subscription services, parental controls, content/advertisement tracking, private network access (e.g., identifier-based routing to private SSIDs, etc.), and/or the like. Third parties, such as network hackers, eavesdroppers, and/or other bad actors, use network sniffing, log tracking, and/or the like to track the identifiers of user devices when connecting to various networks/network devices. To prevent third parties from using an identifier to track user devices when connecting to networks and ensure privacy, many user devices implement identifier randomization. A user device configured with a random identifier is unable to receive identity-based services because the random identifier is an instance-based identifier that is not persisted by a network/network device. For example, a user device using a random identifier to access a public Wi-Fi network at an airport may be directed to a captive portal to submit credentials (e.g., login information, a password, etc.) each time the user device attempts to access the public Wi-Fi network because the network is unable to persist (e.g., store authorization of, etc.) the random identifier. This degrades user experience.

### SUMMARY

It is to be understood that both the following general description and the following detailed description are exemplary and explanatory only and are not restrictive. Methods and systems for enabling identity-based services using a random identifier are described.

A user device (e.g., a mobile device, a smart device, a computer/computing device, a client device, etc.) may send a request to a network device (e.g., access point, gateway, server, captive portal device, etc.) to connect to (e.g., establish a communication session with, etc.) a network (e.g., private network, public network, Internet, etc.) using a random identifier (e.g., a Media Access Control (MAC) address, an International Mobile Subscriber Identity (IMSI), an International Mobile Station Equipment Identity (IMEI), etc.). For example, the user device may perform a handshake communication process (e.g., discovery, offer, request, acknowledgment, three-way handshake, etc.) with the network device using a random identifier, and the network device may provide the user device a network address based on an acknowledgment of the random identifier. The user device may use the network address to send encrypted information to the network device. For example, the encrypted information may be sent via one or more of: Hypertext Transfer Protocol Secure (HTTPS), Extensible Authentication Protocol-Transport Layer Security (EAP-TLS), Secure Sockets Layer (SSL), versions on Wi-Fi Protected Access (WPA, WPA2, WPA3, etc.), Wired Equivalent Privacy (WEP), and/or the like. The encrypted information may include a persistent identifier (e.g., a Media Access Control (MAC) address, an International Mobile Subscriber Identity (IMSI), an International Mobile Station Equipment Identity (IMEI), etc.) of the user device.

The network device may decrypt the encrypted information and associate the random identifier with a persistent identifier. The persistent identifier and/or user device may be associated with one or more identity-based services, such as a login-less network connection and/or reconnection, one or more subscription services, parental controls, content/advertisement tracking, private network access (e.g., identifier-based routing to private SSIDs, etc.), and/or the like. The association between the random identifier and the persistent identifier enables the user device to access the identity-based services. The use of the random identifier mitigates and/or prevents any third party, such as a network hacker, an eavesdropper, and/or any other bad actors, from using network sniffing, log tracking, and/or the like to track the user device when connecting to various networks/network devices.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the methods and systems:

FIG. 1A shows an example system;

FIG. 1B shows an example system;

FIG. 2 shows an example communication diagram;

FIG. 3 shows an example communication diagram;

FIG. 4 shows an example communication diagram;

FIG. 5 shows an example communication diagram;

FIG. 6 shows an example communication diagram;

FIG. 7 shows a flowchart of an example method;

FIG. 8 shows a flowchart of an example method;

FIG. 9 shows a flowchart of an example method;

FIG. 10 shows a flowchart of an example method;

FIG. 11 shows a flowchart of an example method;

FIG. 12 shows a flowchart of an example method;

FIG. 13 shows a flowchart of an example method;

FIG. 14 shows a flowchart of an example method; and

FIG. 15 shows a block diagram of an example computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in the described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text, and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

This detailed description may refer to a given entity performing some action. It should be understood that this language may in some cases mean that a system (e.g., a computer) owned and/or controlled by the given entity is actually performing the action.

A user device (e.g., a mobile device, a smart device, a computer/computing device, a client device, etc.) may implement identifier randomization (e.g. a randomized MAC address, etc.) for security reasons, such as thwarting phishing and/or tracking efforts by nefarious third parties attempting to use a device identifier to build a history of device activity. The non-persistent nature of the random identifier may not facilitate (e.g., may not be configured to facilitate, may disable and/or may prevent) access to one or more identity-based services associated with the user device that rely on persistent/consistent identification of the user device. For example, a user device using a random identifier to access a public Wi-Fi network at an airport may be directed to a captive portal to submit credentials (e.g., login information, a password, etc.) each time the user device attempts to access the public Wi-Fi network because the network is unable to persist (e.g., store authorization of, etc.) the random identifier. Uniquely identifying a user device using a random identifier resolves such issues.

A user device (e.g., a mobile device, a smart device, a computer/computing device, a client device, etc.) may send a request to a network device (e.g., an access point, a gateway, a Wi-Fi server, a captive portal device, etc.) to connect to (e.g., establish a communication session with, etc.) a network (e.g., a private network, a public network, Internet, etc.) using a random identifier (e.g., a MAC address, an IMSI, an IMEI, etc.). For example, the user device may perform a handshake communication process (e.g., a Dynamic Host Configuration Protocol (DHCP) handshake, a Remote Authentication Dial-In User Service (RADIUS) handshake, a Challenge-Handshake Authentication Protocol (CHAP) session, a three-way handshake, etc.) and/or authentication scheme with the network device using the random identifier, and the network device may provide the user device a network address based on an acknowledgment of the random identifier. The user device may use the network address to send encrypted information to the network device. For example, the encrypted information may be sent via one or more of: HTTPS, EAP-TLS, SSL, WPA, WPA2, WPA3, WEP, combinations thereof, and/or the like. The encrypted information may include a persistent identifier (e.g., a MAC address, an IMSI, an IMEI, etc.) of the user device. The encrypted information may include, for example, packaged metadata, a digital certificate, an identity certificate, an SSL certificate, and/or the like.

The network device may decrypt the encrypted information, for example, using one or more cryptographic keys (e.g., public keys, a public/private key pair, etc.). The network device may determine the persistent identifier from the decrypted information. The persistent identifier and/or user device may be associated with one or more identity-based services, such as a login-less network connection and/or reconnection, one or more subscription services, parental controls, content/advertisement tracking, private network access (e.g., identifier-based routing to private SSIDs, etc.), and/or the like.

The network device may associate the random identifier with the persistent identifier. For example, the network device may populate a table comprising one or more fields wherein a first field of the one or more fields is populated with the random identifier and wherein a second field of the one or more fields is populated with the persistent identifier. The encrypted information may include a time window and/or expiry of the random identifier. The network device may determine the time window and/or the expiry of the random identifier from the decrypted information and associate the random identifier with the persistent identifier during the time window and/or prior to the expiry of the random identifier. The persistent identifier may enable the user device to access and/or participate in one or more identity-based services associated with the user device. The use of the random identifier mitigates and/or prevents any nefarious third party, such as a network hacker, an eavesdropper, and/or the like from using network sniffing, log tracking, and/or the like to track the identifier of the user device when connecting to various networks/network devices.

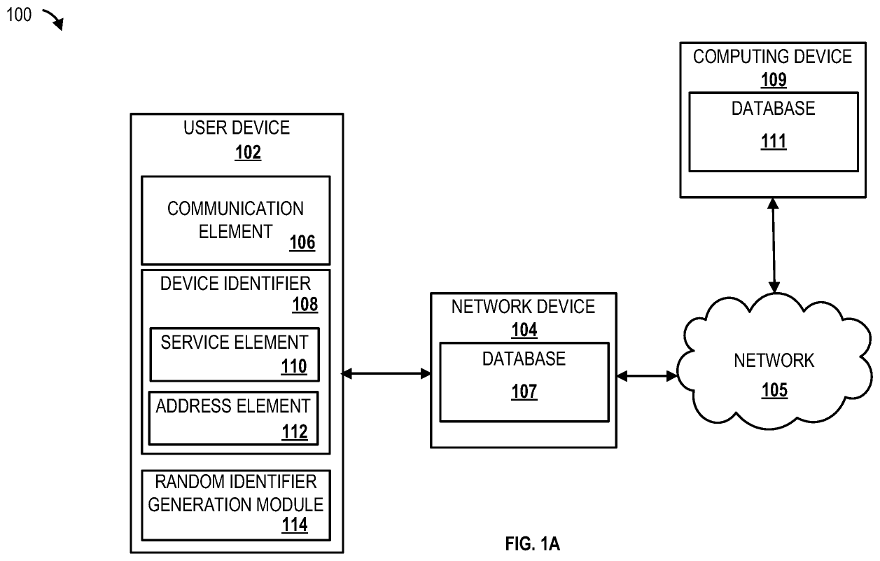

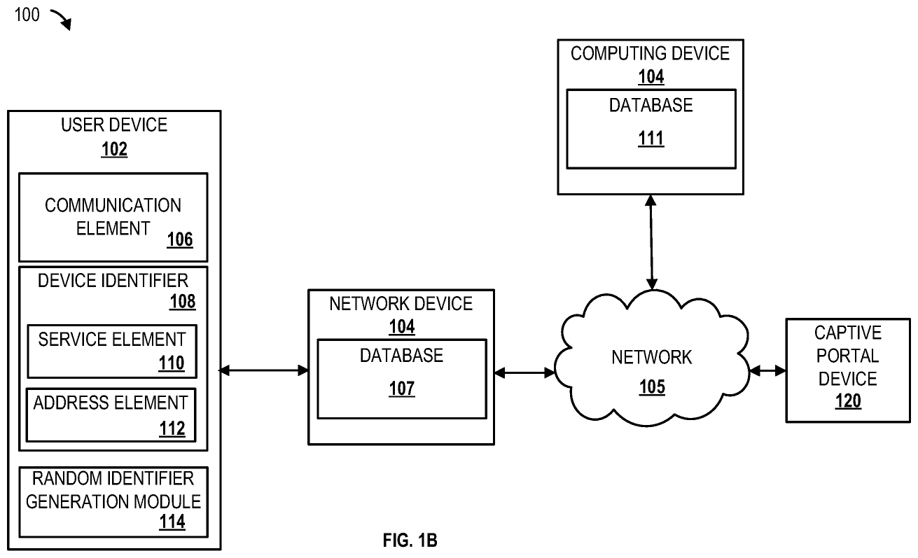

FIG. 1A shows an example system 100. The system 100, for example, may enable identity-based services using a random identifier. The system 100 may include a user device 102 (e.g., a mobile device, a smart device, a computer/computing device, a client device, etc.). The user device 102 may comprise a communication element 106 for providing an interface to a user to interact with the user device 102 and/or any other device/component of the system 100. The communication element 106 may be any interface for presenting and/or receiving information to/from the user, such as information associated with one or more identity-based services that include, for example, a login-less network connection and/or reconnection, one or more subscription services, parental controls, content/advertisement tracking, private network access (e.g., identifier-based routing to private SSIDs, etc.), and/or the like. The communication element 106 may request or query various files from a local source and/or a remote source. The communication element 106 may transmit data to a local or remote device, such as and/or any device/component of the system 100. The communication element 106 may include a communication interface such as a web browser (e.g., Internet Explorer®, Mozilla Firefox®, Google Chrome®, Safari®, or the like). Other software, hardware, and/or interfaces may be used to provide communication between the user and one or more of the user device 102, a network 105 (e.g., Wi-Fi network, Internet, a private network, a public network, a content delivery network, cellular network, etc.), and any other device/component of the system 100.

The user device 102 may be associated with a user identifier or device identifier 108. The device identifier 108 may be any identifier, token, character, string, or the like, for differentiating one user or user device (e.g., user device 102) from another user or user device. The device identifier 108 may identify a user or user device as belonging to a particular class of users or user devices. The device identifier 108 may comprise information relating to the user device such as a manufacturer, a model or type of device, a service provider associated with the user device 102, a state of the user device 102, a locator, and/or a label or classifier. Other information may be represented by the device identifier 108.

The device identifier 108 may comprise a service element 110 and an address element 112. The service element 110 may comprise an identification of a service provider associated with the user device 102 and/or with the class of user device 102. The class of the user device 102 may be related to a type of device, the capability of the device, the type of service being provided, and/or a level of service (e.g., business class, service tier, service package, etc.). The service element 110 may comprise information relating to and/or provided by a communication service provider (e.g., Internet service provider) that is providing or enabling data flow such as communication services to the user device 102. The service element 110 may comprise information relating to a preferred service provider for one or more particular services relating to the user device 102. The service element 110 may be used to identify or retrieve data from the address element 112, or vice versa. Other information may be represented by and/or associated the service element 110.

The address element 112 may include, provide, and/or be associated with an internet protocol (IP) address, a network address, a MAC address, an IMSI, an IMEI, an Internet address, or the like. The address element 112 may be relied upon to establish a communication session between the user device 102, any other device/component of the system 100, other devices, and/or networks. The address element 112 may be used as an identifier or locator of the user device 102. The address element 112 may be persistent for a particular network.

The device identifier 108 (e.g., the address element 112, the service element 110, etc.) may be stored remotely from the user device 102 and retrieved by one or more devices such as the user device 102 and/or any other device/component of the system 100. For example, the device identifier 108 may be a persistent identifier that may be stored remotely from the user device 102 and retrieved by one or more devices such as the user device 102 and/or any other device/component of the system 100 to associate, access, engage, and/or participate with one or more identity-based services. The device identifier 108 enables the user device 102 to associate, access, engage, and/or participate with one or more identity-based services, such as a login-less network connection and/or reconnection, one or more subscription services, parental controls, content/advertisement tracking, private network access (e.g., identifier-based routing to private SSIDs, etc.), and/or the like.

The user device may include a random identifier generator (RIG) 114. The RIG 114 may generate random identifiers, pseudo-random identifiers, and/or the like associated with the user device 102, such as a random/pseudo-random MAC address, a random/pseudo-random IMSI, a random/pseudo-random IMEI, and/or any other random/pseudo-random identifier. The RIG 114 may use any algorithm and/or method to generate random identifiers, pseudo-random identifiers, and/or the like. The RIG 114 may use the device identifier 108 as a template for generating random identifiers, pseudo-random identifiers, and/or the like. For example, a random identifier may be determined by manipulating, updating, and/or changing one or more elements (e.g., values, numbers, characters, symbols, etc.) of the device identifier 108 to a random element. For example, a MAC address, IMSI, IMEI, or other identifier associated with the user device may be input into a hash function and the random identifier may be. The hash function may comprise any suitable hash function. For example, the has function may comprise an identity hash function, a trivial hash function, a folding hash function, a mid-squares hash function, a division hash function, an algebraic hash function, a unique permutation hash function, a multiplicative hash function, a Fibonacci hash function, a Zobrist hash function or any other suitable hash function. The RIG 114 may determine a random identifier based on completely random elements represented in any format. The RIG 114 may determine a random identifier based on one or more original equipment manufacturer (OEM) configurations, protocols, and/or instructions.

Any identifier generated by the RIG 114 may be associated with a time window and/or expiry. For example, the time window and/or expiry may indicate a duration during which a random identifier, a pseudo-random identifier, and/or the like generated by the RIG 114 is valid and/or available for the user device 102 to use when connecting (e.g., establishing a communication session, associating with a network device, etc.) and/or reconnecting to a network, such as the network 105 (e.g., Wi-Fi network, Internet, a private network, a public network, a content delivery network, cellular network, etc.). The time window and/or expiry may be preset and/or preconfigured with the user device 102, for example, based on one or more original equipment manufacturer (OEM) configurations, protocols, and/or instructions. The time window and/or expiry may comprise an arbitrary and/or randomly determined time window and/or expiry.

The user device 102 may use a random identifier (e.g., a random MAC address, a random IMSI, a random IMEI, etc.) generated by the RIG 114 when probing for new networks (e.g., when the user device 102 is associated with a network, etc.). For example, the user device 102 may send a request to a network device 104 to connect to (e.g., establish a communication session with, etc.) the network 105. The request may include a random identifier. For example, to associate with the network 105, the user device may perform a handshake communication process (e.g., a Dynamic Host Configuration Protocol (DHCP) handshake, a Remote Authentication Dial-In User Service (RADIUS) handshake, a Challenge-Handshake Authentication Protocol (CHAP) session, a three-way handshake, etc.) and/or authentication scheme with the network device 104 using the random identifier.

The network device 104 may include an access point, a gateway, a Wi-Fi server, and/or the like associated with the network 105. The network device 104 may be configured with a first service set identifier (SSID) (e.g., associated with a user network or private network) to function as a local network (of and/or associated with the network 105) for the user device 102. The local network may be an identity-based service network associated with the device identifier 108 and/or the user device 102. The network device 104 may be configured with a second service set identifier (SSID) (e.g., associated with a public/community network or a hidden network) to function as a secondary network or redundant network (of and/or associated with the network 105).

The network device 104, based on a successful handshake communication process (e.g., a Dynamic Host Configuration Protocol (DHCP) handshake, a Remote Authentication Dial-In User Service (RADIUS) handshake, a Challenge-Handshake Authentication Protocol (CHAP) session, a three-way handshake, etc.) and/or authentication scheme with the user device 102, may provide the user device 102 a network address, such as an internet protocol (IP) address, and/or the like, along with any additional configuration information associated with the network 105. For example, the network device 104, based on the request from the user device 102 to connect to the network 105, may request and receive authentication information, such as packaged metadata, a public certificate, a digital certificate, an identity package/certificate, an SSL certificate, and/or the like, from a trustworthy central authority (not shown). The authentication information may include and/or be associated with one or more encryption elements, such as one or more public/private cryptographic key pairs, a session key, and/or the like. The trustworthy central authority may include an authentication authority/device, a central digital certification authority, and/or the like. The network device 104 may send the network address and the authentication information to the user device 102.

The user device 102 may use the network address and the authentication information to send encrypted information to the network device 104. The user device 102 may use the encryption elements included with the authentication information to encrypt information associated with the user device 102. For example, the user device 102 may use the public cryptographic key and/or the like included with the authentication information to encrypt information associated with the user device 102. The encrypted information may include the device identifier 108 (or any other persistent identifier of the user device 102), session information (e.g., a session key, a key identifier, etc.) and/or stateful information, a signature (e.g., of an entity that has verified/issued the authentication information, etc.) and/or any other authorization indicator, and a time window that indicates a duration during which the authentication information is valid.

The network address and the authentication information enables the user device 102 to securely send the encrypted information, such as via a secure channel of the network 105. For example, the user device 102 may send the encrypted information to the network device 104 via one or more of: HTTPS, EAP-TLS, SSL, WPA, WPA2, WPA3, WEP, combinations thereof, and/or the like. The network device 104 may decrypt the encrypted information. For example, the network device 104 may use a private cryptographic key associated with the public cryptographic key included with the authentication information to decrypt the encrypted information. For example, the network device may be configured to use the hash function to determine, based on the random identifier, the persistent identifier. The hash function may comprise any suitable hash function. For example, the has function may comprise an identity hash function, a trivial hash function, a folding hash function, a mid-squares hash function, a division hash function, an algebraic hash function, a unique permutation hash function, a multiplicative hash function, a Fibonacci hash function, a Zobrist hash function or any other suitable hash function.

The network device 104 may determine the device identifier 108 (e.g., the persistent identifier of the user device 102, etc.) from the decrypted information. The network device 104 may associate the random identifier received from the user device 102 with the device identifier 108. The network device 104 may include a database 107. The database 107 may store a mapping/association (e.g., an indication of a mapping/association, etc.) between the random identifier and the device identifier 108. The network device 104 may store the mapping/association between the random identifier and the device identifier 108 for a time period and/or duration. For example, network device 104 may store the mapping/association between the random identifier and the device identifier 108 for a time period and/or duration indicated by the encrypted information received from the user device, for a time period and/or duration determined based on a network connection history associated with the device identifier 108, for a time period and/or duration determined based on one or more network conditions (e.g., latency, bandwidth, fault history, etc.), and/or any time period and/or duration. The mapping/association between the random identifier and the device identifier 108 may be implemented, for example, for a duration and/or as desired by a service provider, a network controller, the network device 104, and/or any other device/component of the system 100. The mapping/association between the random identifier and the device identifier 108 may be deleted each time a communication session between the user device 102 and the network 105 terminates and/or is terminated. The mapping/association between the random identifier and the device identifier 108 may be based on a time/duration associated with the DHCP lease and/or the like.

The network device 104, based on the mapping/association between the random identifier and the device identifier 108, may enable the user device 102 to connect (e.g., establish a communication session, etc.) to the network 105 using the random identifier. For example, the user device 102 may send/receive physical layer and/or data layer data/information to/from the network 105 and/or any other device/component of the system 100 using the random identifier.

The network device 104 may send the mapping/association (e.g., an indication of the mapping/association, etc.) between the random identifier and the device identifier 108 to a computing device 109. The computing device 109 may include a Wi-Fi server, a content source, an application server, a service provider device, a router, a local area network (LAN) management/control device, and/or the like. The computing device 109 may include a database 111. The computing device 109 may store the mapping/association between the random identifier and the device identifier 108 for the time period and/or duration in the database 111. The computing device 109 may be associated with, provide, facilitate, and/or service one or more identity-based services associated with the user device 102 and/or the device identifier 108, such as a login-less network connection and/or reconnection, one or more subscription services, parental controls, content/advertisement tracking, private network access (e.g., identifier-based routing to private SSIDs, etc.), and/or the like.

The network device 104, based on the mapping/association between the random identifier and the device identifier 108, enables the user device 102 to connect (e.g., establish a communication session, etc.) to the network 105 using the random identifier. For example, the user device 102 may send/receive physical layer and/or data layer data/information to/from the network 105 and/or any other device/component of the system 100 using the random identifier. The mapping/association between the random identifier and the device identifier 108 enables the user device 102 to access and/or associate/participate with one or more identity-based services associated with, provided/facilitated by, or serviced by the network device 104, the computing device 109, and/or any other device/component of the system 100, such as a login-less network connection and/or reconnection to the network 105, one or more subscription services, parental controls, content/advertisement tracking, private network access (e.g., identifier-based routing to private SSIDs, etc.), and/or the like. For example, the network device 104, based on the mapping/association between the random identifier and the device identifier 108, may enable the user device 102, to connect to the local network (of and/or associated with the network 105) associated with the device identifier 108 and/or the user device 102; the computing device 109, based on the mapping/association between the random identifier and the device identifier 108, may provide the user device 102 access to one or more content items, resources, and/or the like associated with the device identifier 108; the user device 102, based on the mapping/association between the random identifier and the device identifier 108, may be restricted (e.g., via one or more parental control, etc.) from accessing one or more resources/files, websites, and/or the like via the network 105.

The use of the random identifier mitigates and/or prevents any nefarious third party, such as a network hacker, an eavesdropper, and/or the like from using network sniffing, log tracking, and/or the like to track the device identifier 108 when the user device 102 communicates with the network device 104 and/or connects/reconnects to any device/component of the system 100.

FIG. 1B shows the example system 100 for enabling identity-based services using a random identifier. The system 100 includes a captive portal device 120.

As described, based on an association (handshake) process between the user device 102 and the network device 104 when the user device is attempting an initial connection to the network 105, the network device 104 may send a network address and the authentication information to the user device 102.

The user device 102 may use the network address and the authentication information to send encrypted information. The user device 102 may use encryption elements included with authentication information received from the network device 104 to encrypt information associated with the user device 102. For example, the user device 102 may use the public cryptographic key and/or the like included with the authentication information to encrypt information associated with the user device 102. The encrypted information may include the device identifier 108 (or any other persistent identifier of the user device 102), session information (e.g., a session key, a key identifier, etc.) and/or stateful information, a signature (e.g., of an entity that has verified/issued the authentication information, etc.) and/or any other authorization indicator, and a time window that indicates a duration during which the authentication information is valid.

The network device 104 may route the encrypted information, via a secure channel of the network 105, to the captive portal device 120. For example, the user device 102 may send the encrypted information that is routed to the captive portal device 120 via one or more of HTTPS, EAP-TLS, SSL, WPA, WPA2, WPA3, WEP, combinations thereof, and/or the like. The captive portal device 120 may decrypt the encrypted information. For example, the captive portal device 120 may use a private cryptographic key associated with the public cryptographic key included with the authentication information to decrypt the encrypted information.

The captive portal device 120 may decrypt the encrypted information and determine the device identifier 108 (e.g., the persistent identifier of the user device 102, etc.). The captive portal device 120 may determine a status of the device identifier 108. The captive portal device 120 may determine whether the device identifier 108 is associated with a plurality of user devices authorized to access/connect to the network 105. For example, the captive portal device 120 may determine whether the device identifier 108 is associated with a whitelist of user devices authorized to access/connect to the network 105. If the user device 102 is not associated with the plurality of user devices authorized to access/connect to the network 105, the captive portal device 120 may request one or more authentication credentials from the user device 102.

For example, the captive portal device 120 may generate a login element and/or the like, which includes a graphical user interface that is configured to accept authentication credentials from the user device 102 and/or a user of the user device 102, such as a username, a password, and/or any other type of authentication credential. Any method may be used to receive authentication credentials from the user device 102. The captive portal device 120 may send the login element to the network device 104 and the network device may route the login element to the user device 102. The user device 102 may provide, via the login element, authentication credentials. The network device 104 may send the authentication credentials to the captive portal device 120. The captive portal device 120, based on receiving the authentication credentials, may associate the device identifier 108 with the plurality of user devices authorized to access the network 105. The captive portal device 120 may send an indication of the association between the device identifier 108 and the plurality of user devices authorized to access the network 105 to the network device 104. The network device 104, based on the indication of the association between the device identifier 108 and the plurality of user devices authorized to access the network 105, may establish (and/or enable to be established) a connection and/or communication session between the user device 102, the network 105, and/or any other device/component of the system 100. The connection and/or communication session between the user device 102, the network 105, and/or any other device/component of the system 100 may be terminated.

The user device 102 may send a request to the network device 104 to reconnect and/or re-establish a communication session between the user device 102, the network 105, and/or any other device/component of the system 100. Similar actions/functions, as described for initially connecting and/or establishing a communication session between the user device 102, the network 105, and/or any other device/component of the system 100 may be performed by the network device 104 and/or captive portal device 120 in response to the request to reconnect and/or re-establish a communication session between the user device 102, the network 105, and/or any other device/component of the system 100.

The captive portal device 120 may decrypt the encrypted information and determine the device identifier 108 (e.g., the persistent identifier of the user device 102, etc.). The captive portal device 120 may determine a status of the device identifier 108. The captive portal device 120 may determine that the device identifier 108 is associated with the plurality of user devices authorized to access/connect to the network 105. The captive portal device 120 may send an indication of the association between the device identifier 108 and the plurality of user devices authorized to access the network 105 to the network device 104. The network device 104, based on the indication of the association between the device identifier 108 and the plurality of user devices authorized to access the network 105, may establish (and/or enable to be established) another connection and/or communication session between the user device 102, the network 105, and/or any other device/component of the system 100.

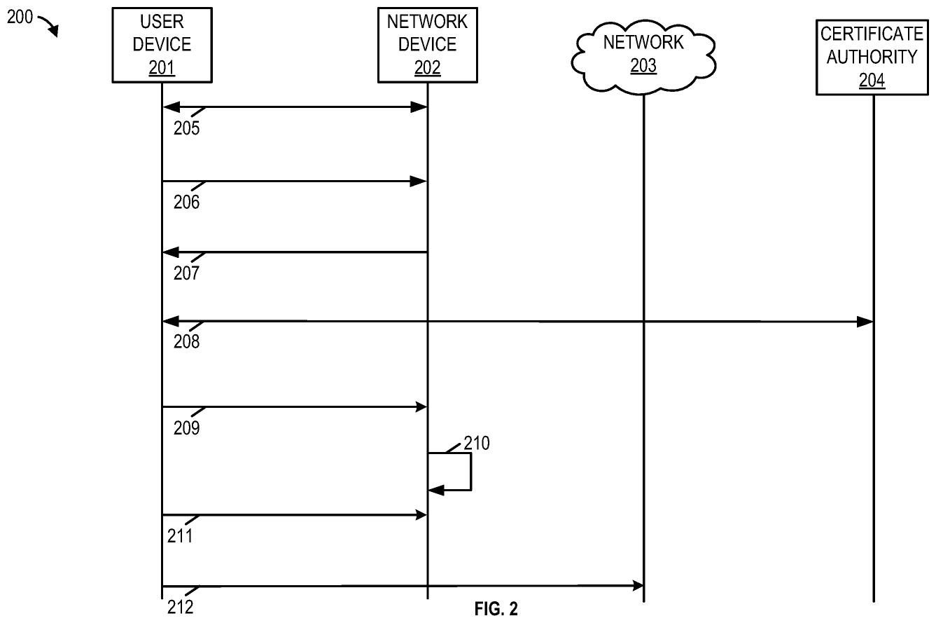

FIG. 2 shows an example communication diagram 200. The example communication diagram 200 describes a scenario where a user device (e.g., a mobile device, a smart device, a computer/computing device, a client device, etc.) is attempting an initial connection to a network, using a random identifier of the user device, to associate, access, engage, and/or participate with one or more identity-based services via the network and/or one or more devices/components of the network.

A user device 201 (e.g., a mobile device, a smart device, a computer/computing device, a client device, etc.) may broadcast and/or otherwise send probe requests using a random identifier (e.g., a random MAC address, a random IMSI, a random IMEI, etc.) of the user device 201 to determine a network device within a communication range of the user device 201 that may facilitate a connection to a network 203 (e.g., Wi-Fi network, Internet, a private network, a public network, a content delivery network, cellular network, etc.). A network device 202 (e.g., an access point, a gateway, a Wi-Fi server, etc.) may be within the communication range of the user device 201, and may respond to the probe request. At 205, the user device 201 and the network device 202 may participate in an authentication (e.g., open system authentication, etc.) and an association (e.g., registration, etc.) process using the random identifier of the user device 201 to identify the user device 201 to the network device 202. The random identifier may be unencrypted. For example, the authentication and association process may exclude and/or not require any data encryption and/or security. The network device may employ any method for determining whether to grant an association with the user device 201.

At 206, based on successful authentication/association between the user device 201 and the network device 202, the user device 201 and the network device 202 may communicate with each other using a communication protocol and/or network management protocol, such as Dynamic Host Configuration Protocol (DHCP), and/or the like. For example, the user device 201 may send a discover message (e.g., DHCP Discover, etc.), such as a request for a network address (e.g., an IP address lease request, etc.).

At 207, based on receiving the discover message, the network device 202 may send an offer message (e.g., DHCP Offer, etc.), such as a response. The response may that include the random identifier of the user device 201, the requested network address, and a time window (e.g., lease duration, etc.) associated with the network address. The time window may indicate a duration during which the network address may be used to connect to the network 203. The offer message may also include a public certificate (e.g., a digital certificate, an identity certificate, an SSL certificate, etc.). For example, at 208, the network device 202 may request the public certificate and/or a resource locator (e.g., URL, etc.) for the public certificate from a certificate issuing entity/authority 204, may receive the requests public certificate and/or the resource locator for the public certificate and may send the public certificate and/or the resource locator for the public certificate to the user device 201 along with the offer message. The public certificate may include and/or be associated with one or more cryptographic keys (e.g., public keys, a public/private key pair, etc.) that may be used to encrypt/decrypt data/information associated with the public certificate.

The user device 201 may receive the public certificate and/or the resource locator for the public certificate to the user device 201 along with the offer message. The user device 201 may verify the integrity of the public certificate and/or the resource locator for the public certificate. For example, the user device 201 may determine whether the public certificate and/or the resource locator for the public certificate is associated with a list of trusted public certificates and/or the resource locators for public certificates.

At 209, in response to the offer message and/or verifying the integrity of the public certificate and/or the resource locator for the public certificate, the user device 201 may send an indication (e.g., DHCP Request, etc.) to the network device 202 accepting the network address offered by the network device 202. The user device 201 may use the network address to send encrypted information to the network device 202. For example, the encrypted information may be sent via one or more of: HTTPS, EAP-TLS, SSL, WPA, WPA2, WPA3, WEP, combinations thereof and/or the like. The encrypted information may include a persistent identifier (e.g., a MAC address, an IMSI, an IMEI, etc.) of the user device 201. The encrypted information may include, for example, packaged metadata based on and/or associated with the public certificate received from the network device 202. The encrypted information may include an indication of a time window. The time window may be any time during which the random identifier is to be associated with the persistent identifier.

The network device 202 may decrypt the encrypted information, for example, using one or more cryptographic keys (e.g., public keys, a public/private key pair, etc.). The network device 202 may determine the persistent identifier from the decrypted information. The encrypted information may include a time window and/or expiry of the random identifier. The network device 202 may determine the time window and/or the expiry of the random identifier from the decrypted information and associate the random identifier with the persistent identifier during the time window and/or prior to the expiry of the random identifier.

At 210, the network device 202 may store mapping and/or indication of an association between the random identifier and the persistent identifier. The network device 202 may associate the random identifier with the persistent identifier. The use of the random identifier mitigates and/or prevents any nefarious/malicious third party, such as a network hacker, an eavesdropper, and/or the like from using network sniffing, log tracking, and/or the like to track the identifier of user device 201 when connecting to various networks/network devices (e.g., the network device 202, etc.). The association between the random identifier and the persistent identifier may enable the user device 201 to access and/or participate in one or more identity-based services associated with the user device 201.

At 211, the network device 202, based on the mapping and/or indication of an association between the random identifier and the persistent identifier, may enable the user device 201 to connect (e.g., establish a communication session, etc.) to the network 203 using the random identifier. For example, the user device 201 may send/receive physical layer (OSI Layer 1) and/or data layer (OSI Layer 2) data/information to/from the network 203 and/or any other device/component of the system 100 using the random identifier.

At 212, the user device 201 may associate, access, engage, and/or participate with one or more identity-based services via the network 203. The persistent identifier and/or user device 201 may be associated with one or more identity-based services, such as a login-less network connection and/or reconnection, one or more subscription services, parental controls, content/advertisement tracking, private network access (e.g., identifier-based routing to private SSIDs, etc.), and/or the like. For example: the network device 202, based on the mapping/association between the random identifier and the persistent identifier, may enable the user device 201, to connect to a local network (of and/or associated with the network 203) associated with the persistent identifier and/or the user device 201; a Wi-Fi server, a content delivery device, an application server/device, a service provider device, a router, a local area network (LAN) management/control device, and/or the like, based on the mapping/association between the random identifier and the persistent identifier, may provide the user device 201 access to one or more content items, resources, and/or the like associated with the persistent identifier; the user device 201, based on the mapping/association between the random identifier and the persistent identifier, may be restricted (e.g., via one or more parental control, etc.) from accessing one or more resources/files, websites, and/or the like via the network 203. The user device 201 may associate, access, engage, and/or participate with any type of identity-based service based on the persistent identifier.

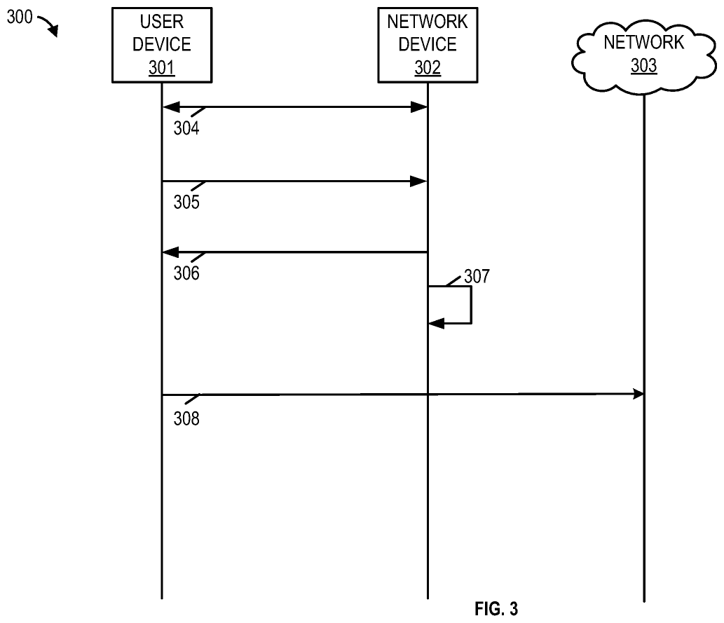

FIG. 3 shows an example communication diagram 300 for enabling identity-based services using a random identifier. The example communication diagram 300 describes a scenario where a user device (e.g., a mobile device, a smart device, a computer/computing device, a client device, etc.) is attempting a subsequent connection to a network, after initially connecting to the network, using a random identifier of the user device, to associate, access, engage, and/or participate with one or more identity-based services via the network and/or one or more devices/components of the network.

A user device 301 (e.g., a mobile device, a smart device, a computer/computing device, a client device, etc.) may broadcast and/or otherwise send probe requests using a random identifier (e.g., a random MAC address, a random IMSI, a random IMEI, etc.) of the user device 301 to determine a network device within a communication range of the user device 301 that may facilitate a connection to a network 303 (e.g., Wi-Fi network, Internet, a private network, a public network, a content delivery network, cellular network, etc.). The random identifier may be the same random identifier that the user device 301 used in the initial connection to the network 303 or a new random identifier. As explained herein in further detail, a temporary mapping between a persistent identifier (e.g., a MAC address, an IMSI, an IMEI, etc.) of the user device 301 and a random identifier may be stored, for example in a database associated with and/or accessible by a network device 302, for a faster authentication between the user device 301 and the network device 302.

The network device 302 (e.g., an access point, a gateway, a Wi-Fi server, etc.) may be within the communication range of the user device 301 and may respond to the broadcast probe request. At 304, the user device 301 and the network device 302 may participate in an authentication (e.g., open system authentication, etc.) and an association (e.g., registration, etc.) process using the random identifier of the user device 301 to identify the user device 301 to the network device 302. The random identifier may be unencrypted. For example, the authentication and association process may exclude and/or not require any data encryption and/or security. The network device may employ any method for determining whether to grant an association with the user device 301.

At 305, based on successful authentication/association between the user device 301 and the network device 302, the user device 301 and the network device 302 may communicate with each other using a communication protocol and/or network management protocol, such as Dynamic Host Configuration Protocol (DHCP), and/or the like. For example, the user device 301 may send a discover message (e.g., DHCP Discover, etc.), such as a request for a network address (e.g., an IP address lease request, etc.).

At 306, based on the discover message, the network device 302 may send an offer message (e.g., DHCP Offer, etc.), such as a response that includes the random identifier of the user device 301, the requested network address, and a time window (e.g., lease duration, etc.) associated with the network address. The time window may indicate a duration during which the network address may be used to connect to the network 303.

At 307, the network device 302 may determine a mapping and/or indication of an association between the random identifier and the persistent identifier of the user device 301. The network device 302 may determine that mapping and/or an indication of an association between the random identifier and the persistent identifier is stored, for example, in a database associated with the network device. The mapping and/or indication of an association between the random identifier and the persistent identifier may enable the user device 301 to access and/or participate in one or more identity-based services associated with the user device 301. The random identifier may be stored with a mapping to the persistent identifier (e.g., a MAC address, an IMSI, an IMEI, etc.) of the user device 201, for example, based on a previous connection to the network 303.

At 308, the user device 301 may associate, access, engage, and/or participate with one or more identity-based services via the network 303. The persistent identifier and/or user device 301 may be associated with one or more identity-based services, such as a login-less network connection and/or reconnection, one or more subscription services, parental controls, content/advertisement tracking, private network access (e.g., identifier-based routing to private SSIDs, etc.), and/or the like. For example, the network device 302, based on the mapping/association between the random identifier and the persistent identifier, may enable the user device 301, to connect to a local network (of and/or associated with the network 303) associated with the persistent identifier and/or the user device 301; a Wi-Fi server, a content delivery device, an application server/device, a service provider device, a router, a local area network (LAN) management/control device, and/or the like, based on the mapping/association between the random identifier and the persistent identifier, may provide the user device 301 access to one or more content items, resources, and/or the like associated with the persistent identifier; the user device 301, based on the mapping/association between the random identifier and the persistent identifier, may be restricted (e.g., via one or more parental control, etc.) from accessing one or more resources/files, websites, and/or the like via the network 303. The user device 301 may associate, access, engage, and/or participate with any type of identity-based service based on the persistent identifier.

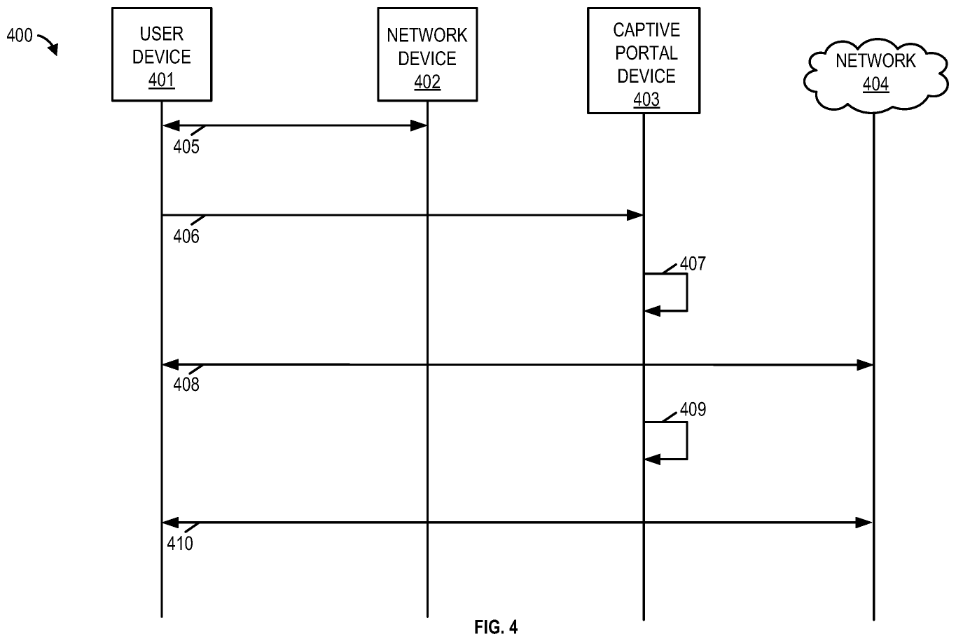

FIG. 4 shows an example communication diagram 400. The example communication diagram 400 describes a scenario where a user device (e.g., a mobile device, a smart device, a computer/computing device, a client device, etc.) is attempting an initial connection to a network, such as a public Wi-Fi network, using a random identifier of the user device, to associate, access, engage, and/or participate with one or more identity-based services via the network and/or one or more devices/components of the network. Uniquely identifying a user device using a random identifier resolves such issues.

A user device 401 (e.g., a mobile device, a smart device, a computer/computing device, a client device, etc.) may broadcast and/or otherwise send a probe request comprising a random identifier (e.g., a random MAC address, a random IMSI, a random IMEI, etc.) of the user device 401. Based on the probe request, the user device 401 may determine a network device within communication range of the user device 401 that may facilitate a connection to a network 404 (e.g., Wi-Fi network, Internet, a private network, a public network, a content delivery network, cellular network, etc.). A network device 402 (e.g., an access point, a gateway, a Wi-Fi server, etc.) may be within the communication range of the user device 401 and may respond to the probe request. Based on the response to the probe request, the user device 401 may perform a handshake communication process (e.g., discovery, offer, request, acknowledgment, three-way handshake, etc.) with the network device 402 using the random identifier to authenticate the user device 401 and associate the user device 401 with the network device 402. The network device 402 may provide the user device 401 a network address (e.g., IP address, etc.) based on an acknowledgment of the random identifier.

The user device 401 and the network device 402, based on successful authentication/association between the user device 401 and the network device 402, may communicate with each other using a communication protocol and/or network management protocol, such as Dynamic Host Configuration Protocol (DHCP), and/or the like. For example, the user device 401 may send a discover message (e.g., DHCP Discover, etc.), such as a request for a network address (e.g., an IP address lease request, etc.). The network device 402 may receive the discover message and send with an offer message (e.g., DHCP Offer, etc.), such as a response that includes the random identifier of the user device 401, the requested network address, and a time window (e.g., lease duration, etc.) associated with the network address. The time window may indicate a duration during which the network address may be used to connect to the network 404.

The offer message may include a public certificate (e.g., a digital certificate, an identity certificate, an SSL certificate, etc.). For example, the network device 402 may request the public certificate and/or a resource locator (e.g., URL, etc.) for the public certificate from a certificate issuing entity/authority. The network device 402 may send the public certificate and/or the resource locator for the public certificate to the user device 401 along with the offer message. The public certificate may include and/or be associated with one or more cryptographic keys (e.g., public keys, a public/private key pair, etc.) that may be used to encrypt/decrypt data/information associated with the public certificate.

The user device 401 may receive the public certificate and/or the resource locator for the public certificate to the user device 401 along with the offer message. The user device 401 may verify the integrity of the public certificate and/or the resource locator for the public certificate. For example, the user device 401 may determine whether the public certificate and/or the resource locator for the public certificate is associated with a list of trusted public certificates and/or the resource locators for public certificates.

At 405, in response to the offer message and/or verifying the integrity of the public certificate and/or the resource locator for the public certificate, the user device 401 may send a request (e.g., DHCP Request, etc.) to the network device 402 accepting the network address offered by the network device 402. The user device may use the network address to send encrypted information to the network device 402. For example, the encrypted information may be sent via one or more of HTTPS, EAP-TLS, SSL, WPA, WPA2, WPA3, WEP, combinations thereof, and/or the like. The encrypted information may include a persistent identifier (e.g., a MAC address, an IMSI, an IMEI, etc.) of the user device 401. The encrypted information may include, for example, packaged metadata based on and/or associated with the public certificate received from the network device 402.

At 406, the network device 402 may route/send the request to a captive portal device 403. At 407, the captive portal device 403 may decrypt the encrypted information, for example, using one or more cryptographic keys (e.g., public keys, a public/private key pair, etc.). The captive portal device 403 may determine the persistent identifier from the decrypted information. The captive portal device 403 may determine a status of the persistent identifier. The captive portal device 403 may determine that the persistent identifier is not associated with a plurality of user devices authorized to access/connect to the network 404. For example, the captive portal device 403 may determine that the persistent identifier is not associated with a whitelist of user devices authorized to access/connect to the network 404.

At 408, the captive portal device 403, based on determining that the persistent identifier is not associated with the plurality of user devices authorized to access/connect to the network 404, may request one or more authentication credentials from the user device 401. For example, the captive portal device 403 may generate a login element and/or the like, that includes a graphical user interface that is configured to accept authentication credentials from the user device 401 and/or a user of the user device 401, such as a username, a password, and/or any other type of authentication credential. The captive portal device 403 may send a request for authentication credentials, for example via the login element, to the network device 402 and the network device may route the request to the user device 401. The user device 401 may provide, for example via the login element, the authentication credentials. The network device 402 may send the authentication credentials to the captive portal device 403.

At 409, the captive portal device 403, based on receiving the authentication credentials, may associate the persistent identifier with the plurality of user devices authorized to access the network 404. For example, the captive portal device 403 may associate the persistent identifier with the whitelist of user devices authorized to access/connect to the network 404.

At 410, the user device 401 may connect to and/or communicate with the network 404 and receive (e.g., associate with, access, engage, participate with, etc.) one or more identity-based services. For example, the captive portal device 403 may send an indication of the association between the persistent identifier and the whitelist to the network device 402. The network device 402, based on the indication of the association between the persistent identifier and the whitelist, may establish (and/or enable to be established) a connection and/or communication session between the user device 401 and the network 404.

The connection and/or communication session between the user device 401 and the network 404 enables the user device 401 to receive (e.g., associate with, access, engage, participate with, etc.) the one or more identity-based services, such as a login-less network connection and/or reconnection, one or more subscription services, parental controls, content/advertisement tracking, private network access (e.g., identifier-based routing to private SSIDs, etc.), and/or the like.

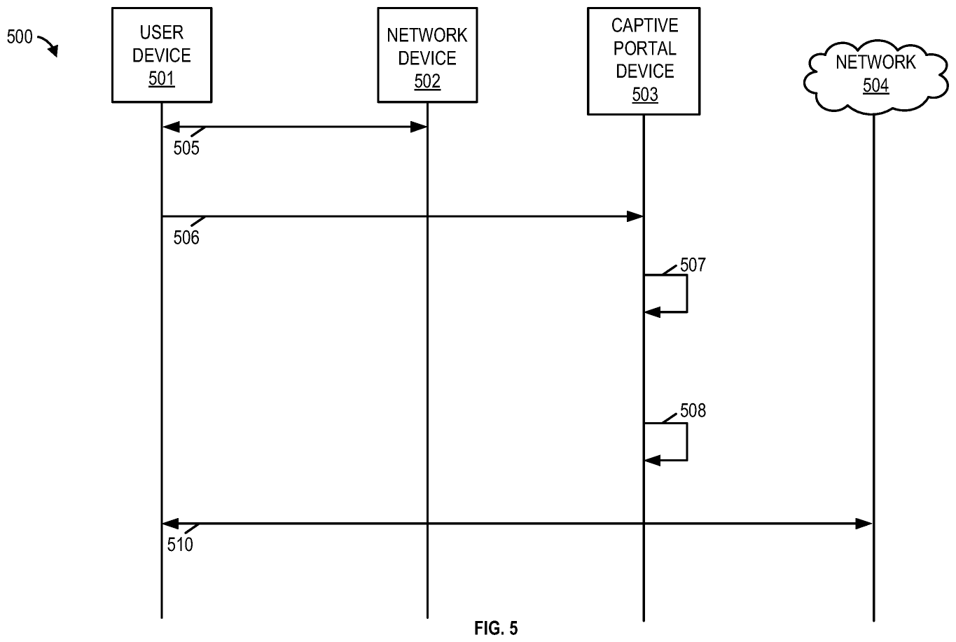

FIG. 5 shows an example communication diagram 500 for enabling identity-based services using a random identifier. The example communication diagram 500 describes a scenario where a user device (e.g., a mobile device, a smart device, a computer/computing device, a client device, etc.) is attempting subsequent connection (after an initial connection has terminated) to a network, such as a public Wi-Fi network, using a random identifier of the user device, to associate, access, engage, and/or participate with one or more identity-based services via the network and/or one or more devices/components of the network.

A user device 501 (e.g., a mobile device, a smart device, a computer/computing device, a client device, etc.) may broadcast and/or otherwise send probe requests using a random identifier (e.g., a random MAC address, a random IMSI, a random IMEI, etc.) of the user device 501 to determine a network device within a communication range of the user device 501 that may facilitate a connection to a network 504 (e.g., Wi-Fi network, Internet, a private network, a public network, a content delivery network, cellular network, etc.). A network device 502 (e.g., an access point, a gateway, a Wi-Fi server, etc.) may be within the communication range of the user device 501 and may respond to the broadcast/probe request. The user device 501 may perform a handshake communication process (e.g., discovery, offer, request, acknowledgment, three-way handshake, etc.) with the network device 502 using a random identifier to authenticate the user device 501 and associate the user device 501 with the network device 502. The network device 502 may provide the user device 501 a network address (e.g., IP address, etc.) based on an acknowledgment of the random identifier.

The user device 501 and the network device 502, based on successful authentication/association between the user device 501 and the network device 502, may communicate with each other using a communication protocol and/or network management protocol, such as Dynamic Host Configuration Protocol (DHCP), and/or the like. For example, the user device 501 may send a discover message (e.g., DHCP Discover, etc.), such as a request for a network address (e.g., an IP address lease request, etc.). The network device 502 may receive the discover message and send with an offer message (e.g., DHCP Offer, etc.), such as a response that includes the random identifier of the user device 501, the requested network address, and a time window (e.g., lease duration, etc.) associated with the network address. The time window may indicate a duration during which the network address may be used to connect to the network 504.

The offer message may include a public certificate (e.g., a digital certificate, an identity certificate, an SSL certificate, etc.). For example, the network device 502 may request the public certificate and/or a resource locator (e.g., URL, etc.) for the public certificate from a certificate issuing entity/authority. The network device 502 may send the public certificate and/or the resource locator for the public certificate to the user device 501 along with the offer message. The public certificate may include and/or be associated with one or more cryptographic keys (e.g., public keys, a public/private key pair, etc.) that may be used to encrypt/decrypt data/information associated with the public certificate.

The user device 501 may receive the public certificate and/or the resource locator for the public certificate to the user device 501 along with the offer message. The user device 501 may verify the integrity of the public certificate and/or the resource locator for the public certificate. For example, the user device 501 may determine whether the public certificate and/or the resource locator for the public certificate is associated with a list of trusted public certificates and/or the resource locators for public certificates.

At 505, in response to the offer message and/or verifying the integrity of the public certificate and/or the resource locator for the public certificate, the user device 501 may send a request (e.g., DHCP Request, etc.) to the network device 502 accepting the network address offered by the network device 502. The user device may use the network address to send encrypted information to the network device 502. For example, the encrypted information may be sent via one or more of HTTPS, EAP-TLS, SSL, WPA, WPA2, WPA3, WEP, combinations thereof, and/or the like. The encrypted information may include a persistent identifier (e.g., a MAC address, an IMSI, an IMEI, etc.) of the user device 501. The encrypted information may include, for example, packaged metadata based on and/or associated with the public certificate received from the network device 502.

At 506, the network device 502 may route/send the request to a captive portal device 503. At 507, the captive portal device 503 may decrypt the encrypted information, for example, using one or more cryptographic keys (e.g., public keys, a public/private key pair, etc.). The captive portal device 503 may determine the persistent identifier from the decrypted information.

At 508, The captive portal device 503 may determine a status of the persistent identifier. The captive portal device 503 may determine that the persistent identifier is associated with a plurality of user devices authorized to access/connect to the network 504. For example, the captive portal device 503 may determine that the persistent identifier is associated with a whitelist of user devices authorized to access/connect to the network 504.

At 510, the user device 501 may connect to and/or communicate with the network 504 and receive (e.g., associate with, access, engage, participate with, etc.) one or more identity-based services. For example, the captive portal device 503 may send an indication of the association between the persistent identifier and the whitelist to the network device 502. The network device 502, based on the indication of the association between the persistent identifier and the whitelist, may establish (and/or enable to be established) a connection and/or communication session between the user device 501 and the network 504.

The connection and/or communication session between the user device 501 and the network 504 enables the user device 501 to receive (e.g., associate with, access, engage, participate with, etc.) the one or more identity-based services, such as a login-less network connection and/or reconnection, one or more subscription services, parental controls, content/advertisement tracking, private network access (e.g., identifier-based routing to private SSIDs, etc.), and/or the like.

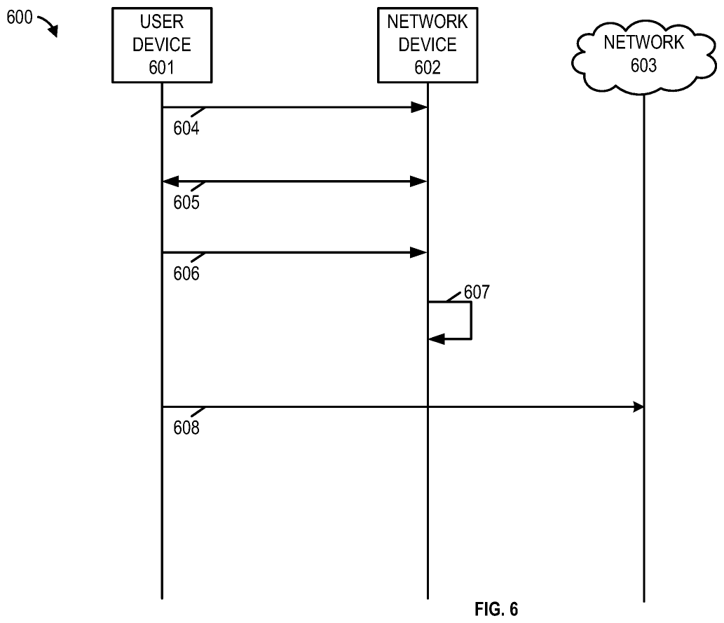

FIG. 6 shows an example communication diagram 600. The example communication diagram 600 describes a scenario where a user device (e.g., a mobile device, a smart device, a computer/computing device, a client device, etc.) sends a request to gain access to a network using a random identifier of the user device, to associate, access, engage, and/or participate with one or more identity-based services via the network and/or one or more devices/components of the network.

At 604, a user device 601 (e.g., a mobile device, a smart device, a computer/computing device, a client device, etc.) may send a request to a network device 602 (e.g., an access point, a gateway, a Wi-Fi server, etc.) to connect to a network 603 (e.g., Wi-Fi network, Internet, a private network, a public network, a content delivery network, cellular network, etc.) using a random identifier (e.g., a random MAC address, a random IMSI, a random IMEI, etc.) of the user device 601.

At 605, A trust relationship between the user device 601 and the network device 602 may be determined/established. For example, based on successful authentication/association between the user device 601 and the network device 602, the user device 601 and the network device 602 may communicate with each other using a communication protocol and/or network management protocol, such as Dynamic Host Configuration Protocol (DHCP), and/or the like. The trust relationship may be based on a successful handshake process (e.g., a DHCP 4-way handshake, etc.) between the user device 601 and the network device 602.

The network device 602 may obtain/request a public certificate (e.g., a digital certificate, an identity certificate, an SSL certificate, etc.) from a certificate issuing entity/authority and send the public certificate (and/or the resource locator for the public certificate) to the user device 601. The public certificate may include and/or be associated with one or more cryptographic keys (e.g., public keys, a public/private key pair, etc.) that may be used to encrypt/decrypt data/information associated with the public certificate.

The user device 601 may receive the public certificate and use one or more cryptographic keys to encrypt information, such as a persistent identifier (e.g., a MAC address, an IMSI, an IMEI, etc.) of the user device 601.

At 606, the user device 601 may send encrypted information to the network device 602. The encrypted information may include a persistent identifier (e.g., a MAC address, an IMSI, an IMEI, etc.) of the user device 201. The encrypted information may include, for example, packaged metadata based on and/or associated with the public certificate (e.g., one or more cryptographic keys, etc.) received from the network device 602.

At 607, the network device 602 may decrypt the encrypted information, for example, using one or more cryptographic keys (e.g., public keys, a public/private key pair, etc.). The network device 602 may determine the persistent identifier from the decrypted information. The encrypted information may include a time window and/or expiry of the random identifier. The network device 602 may determine the time window and/or the expiry of the random identifier from the decrypted information and associate the random identifier with the persistent identifier during the time window and/or before the expiry of the random identifier.

The network device 602 may store a mapping and/or indication of an association between the random identifier and the persistent identifier. The network device 602 may associate the random identifier with the persistent identifier. The association between the random identifier and the persistent identifier may enable the user device 601 to access and/or participate in one or more identity-based services associated with the user device 601.

At 608, the network device 602, based on the mapping and/or indication of an association between the random identifier and the persistent identifier, may enable the user device 201 to connect (e.g., establish a communication session, etc.) to the network 603 using the random identifier. For example, the user device 601 may send/receive physical layer (OSI Layer 1) and/or data layer (OSI Layer 2) data/information to/from the network 603 and/or any other device/component associated with the network 603 using the random identifier.

The user device 601 may associate, access, engage, and/or participate with one or more identity-based services via the network 603. The persistent identifier and/or user device 601 may be associated with one or more identity-based services, such as a login-less network connection and/or reconnection (e.g., auto-login, etc.), one or more subscription services, parental controls, content/advertisement tracking, private network access (e.g., identifier-based routing to private SSIDs, etc.), and/or the like.

For example, based on the mapping/association between the random identifier and the persistent identifier, the user device 601 may connect to a local network (of and/or associated with the network 603) associated with the persistent identifier and/or the user device 601. The user device 601 may connect to a Wi-Fi server, a content delivery device, an application server/device, a service provider device, a router, a local area network (LAN) management/control device, and/or the like, based on the mapping/association between the random identifier and the persistent identifier. The user device 601 may access to one or more content items, resources, and/or the like associated with the persistent identifier. The user device 601, based on the mapping/association between the random identifier and the persistent identifier, may be restricted (e.g., via one or more parental control, etc.) from accessing one or more resources/files, websites, and/or the like via the network 603. The user device 601 may associate, access, engage, and/or participate with any type of identity-based service based on the persistent identifier.

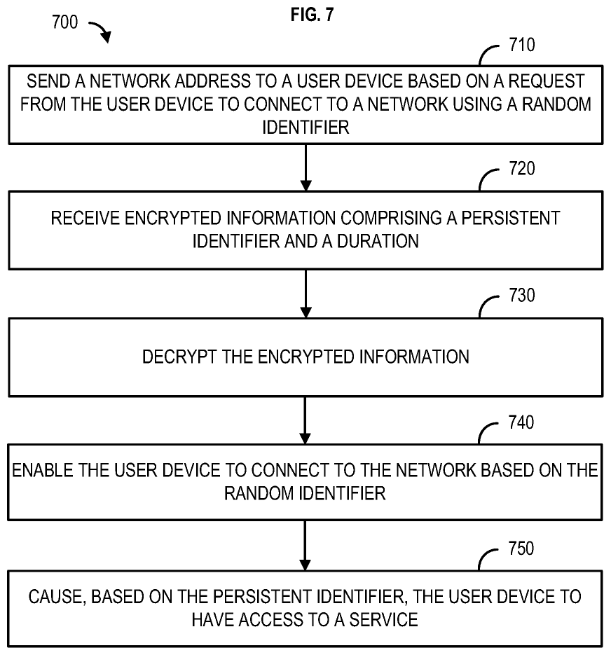

FIG. 7 shows a flowchart of an example method 700 for enabling identity-based services using a random identifier. At 710, a network address (e.g., an IP address, etc.) may be sent to a user device (e.g., a mobile device, a smart device, a computer/computing device, a client device, etc.). A network device (e.g., an access point, a gateway, a Wi-Fi server, etc.) may send the network address to the user device based on a request from the user device to connect to a network (e.g., Wi-Fi network, Internet, a private network, a public network, a content delivery network, cellular network, etc.) using a random identifier (e.g., a random MAC address, a random IMSI, a random IMEI, etc.) of the user device. The network address may be sent to the user device based on successful authentication, association, and hand-shake communication process/protocol (e.g., a DHCP handshake, etc.) between the user device and the network device.

At 720, encrypted information may be received. The network device may receive the encrypted information from the user device based on the network address. For example, the user device may use the network address to send/communicate the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, a IMSI, a IMEI, etc.) of the user device. The encrypted information and/or metadata may include an indication of a time window (duration). The time window may be any time during which the random identifier is to be associated with the persistent identifier. The user device may use the network address to send encrypted information to the network device. For example, the encrypted information may be sent via one or more of: HTTPS, EAP-TLS, SSL, WPA, WPA2, WPA3, WEP, combinations thereof and/or the like.

At 730, the encrypted information may be decrypted. The network device may decrypt the encrypted information. The network device may decrypt the encrypted information, for example, using the one or more cryptographic keys (e.g., public keys, a public/private key pair, etc.). The network device may determine the persistent identifier and the time window from the decrypted information. The network device may store, for example in a database, an association/mapping between the random identifier and the persistent identifier for the duration of the time window.

At 740, the user device may connect to the network. The network device may enable the user device to connect to the network. For example, the user device may send/receive physical layer and/or data layer data/information to/from the network using the random identifier.

At 750, the user device may access a service. For example, the user device may, optionally, connect to and/or communicate with a service. The service may be, for example, an identity based-service. The identity-based service may be enabled based on the persistent identifier. The network device may enable identity-based services associated with the user device. For example, the network device may cause the user device to access the identity-based service by routing the persistent identifier to a service and/or facilitating a connection between the user device and the service. The network device may enable identity-based services associated with the user device during the time window indicated by the encrypted information received from the user device.

For example, during the time window, the network device may enable the user device to connect to a local network associated with the persistent identifier and/or the user device via the network. The user device may be enabled to access one or more content items, resources, and/or the like associated with the persistent identifier. The user device, based on the persistent identifier, may be restricted (e.g., via one or more parental control, etc.) from accessing one or more resources/files, websites, and/or the like via the network. The user device may associate, access, engage, and/or participate with any type of service (e.g., an identity-based service, etc.) based on the persistent identifier.

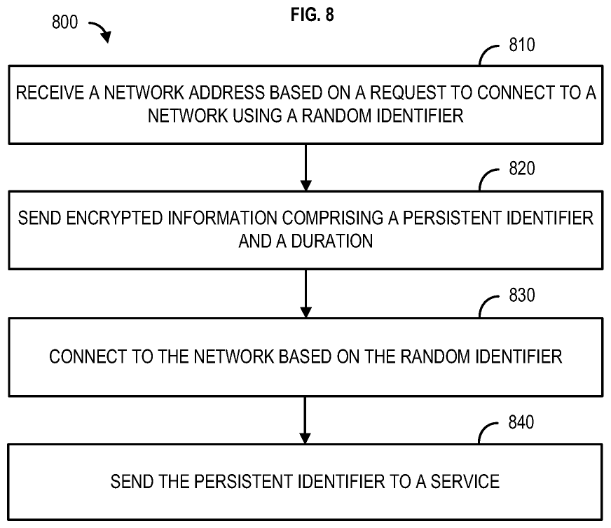

FIG. 8 shows a flowchart of an example method 800 for enabling identity-based services using a random identifier. At 810, a network address (e.g., an IP address, etc.) may be received. The network address may be received by a user device (e.g., a mobile device, a smart device, a computer/computing device, a client device, etc.). The network address may be received by the user device based on a request to connect to a network (e.g., Wi-Fi network, Internet, a private network, a public network, a content delivery network, cellular network, etc.) using a random identifier (e.g., a random MAC address, a random IMSI, a random IMEI, etc.) of the user device. A network device (e.g., an access point, a gateway, a Wi-Fi server, etc.) may send the network address to the user device based on the request to connect to the network. The network address may be sent to the user device based on a successful authentication, association, and hand-shake communication process/protocol (e.g., a DHCP handshake, etc.) between the user device and the network device.

At 820, encrypted information may be sent. Encrypted information may be sent, by the user device, to the network device based on the network address, wherein the encrypted information comprises a persistent identifier of the user device and an indication of a duration, wherein the network device is configured to decrypt the encrypted information. For example, the user device may use the network address to send/communicate the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, a IMSI, a IMEI, etc.) of the user device. The encrypted information and/or metadata may include an indication of a time window (duration). The time window may be any time during which the random identifier is to be associated with the persistent identifier. The user device may use the network address to send encrypted information to the network device. For example, the encrypted information may be sent via one or more of: HTTPS, EAP-TLS, SSL, WPA, WPA2, WPA3, WEP, combinations thereof and/or the like. The network device may decrypt the encrypted information, for example, using the one or more cryptographic keys (e.g., public keys, a public/private key pair, etc.).

The encrypted information may be decrypted. The network device may decrypt the encrypted information. The network device may decrypt the encrypted information, for example, using the one or more cryptographic keys (e.g., public keys, a public/private key pair, etc.). The network device may determine the persistent identifier and the time window from the decrypted information. The network device may store, for example in a database, an association/mapping between the random identifier and the persistent identifier for the duration of the time window.

At 830, the user device may connect to the network. The user device may connect to the network using the persistent identifier. The network device may enable the user device to connect to the network. For example, the user device may send/receive physical layer and/or data layer data/information to/from the network using the random identifier.

At 840, the user device may send the persistent identifier to a service. For example, t user device may, optionally, connect to and/or communicate with a service using the persistent identifier. The service may be, for example, an identity based-service. The user device may receive, for the duration and based on the persistent identifier, any number of identity-based services associated with the user device. The network device may cause and/or enable identity-based services associated with the user device by routing the persistent identifier to an identity-based service and/or facilitating a connection between the user device and an identity-based service (or any other service). The network device may enable identity-based services associated with the user device during the time window indicated by the encrypted information received from the user device.

For example, during the time window, the network device may enable the user device to connect to a local network associated with the persistent identifier and/or the user device via the network. The user device may be enabled to access one or more content items, resources, and/or the like associated with the persistent identifier. The user device, based on the persistent identifier, may be restricted (e.g., via one or more parental control, etc.) from accessing one or more resources/files, websites, and/or the like via the network. The user device may associate, access, engage, and/or participate with any type of identity-based service based on the persistent identifier.

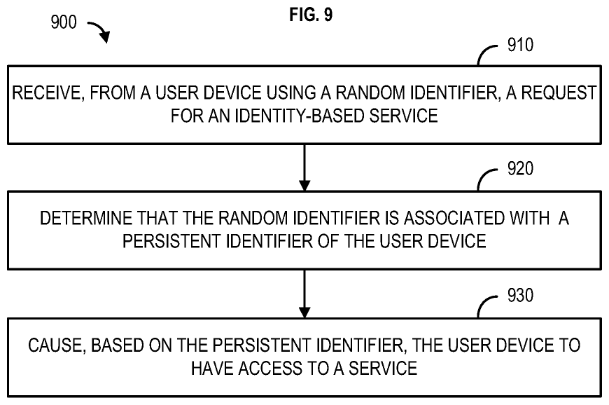

FIG. 9 shows a flowchart of an example method 900 for enabling identity-based services using a random identifier. An identity-based service may include, for example, a login-less network connection and/or reconnection, one or more subscription services, parental controls, content/advertisement tracking, private network access (e.g., identifier-based routing to private SSIDs, etc.), and/or the like. At 910, a request for at least one identity-based service may be received. The request for the identity-based service may be received/associated with a request from a user device (e.g., a mobile device, a smart device, a computer/computing device, a client device, etc.) to connect to a network (e.g., Wi-Fi network, Internet, a private network, a public network, a content delivery network, cellular network, etc.) with a random identifier (e.g., a random MAC address, a random IMSI, a random IMEI, etc.) of the user device. A network device (e.g., an access point, a gateway, a Wi-Fi server, etc.) may receive the request to connect to the network, for example, based on successful authentication, association, and hand-shake communication process/protocol (e.g., a DHCP handshake, etc.) between the user device and the network device. The network device may send, based on the request to connect to the network, a network address (e.g., an IP address, etc.) to the user device. The user device may use the network address to send the random identifier to the network device.

At 920, the network device may determine that the random identifier is associated with a persistent identifier (e.g., a MAC address, a IMSI, a IMEI, etc.) of the user device. The network device may determine that an indication of the random identifier is stored, for example within a database, with an indication of the persistent identifier.

At 930, the user device may access an identity-based service. For example, the user device may, optionally, connect to and/or communicate with an identity-based service. The identity-based services may be enabled based on the persistent identifier. The network device may enable identity-based services associated with the user device. For example, the network device may cause the user device to access the identity-based service by routing the persistent identifier to a service and/or facilitating a connection between the user device and the service. The network device may enable, based on the persistent identifier, identity-based services associated with the user device during the time window indicated by the encrypted information received from the user device. Enabling identity-based services associated with the user device during the time window indicated by the encrypted information received from the user device may allow the user device to connect and/or reconnect to the identity-based service whenever an association between the random identifier (or any other random identifier) and the persistent identifier is determined, for example, by the network device.

The network device may enable the user device to connect to a local network associated with the persistent identifier and/or the user device via the network. The user device may be enabled to access one or more content items, resources, and/or the like associated with the persistent identifier. The user device, based on the persistent identifier, may be restricted (e.g., via one or more parental control, etc.) from accessing one or more resources/files, websites, and/or the like via the network. The user device may associate, access, engage, and/or participate with any type of service (e.g., an identity-based service, etc.) based on the persistent identifier.

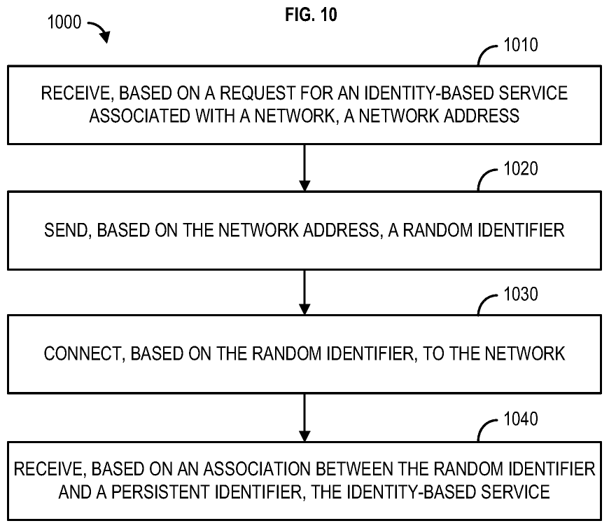

FIG. 10 shows a flowchart of an example method 900 for enabling identity-based services using a random identifier. An identity-based service may include, for example, a login-less network connection and/or reconnection, one or more subscription services, parental controls, content/advertisement tracking, private network access (e.g., identifier-based routing to private SSIDs, etc.), and/or the like. At 1010, a request for at least one identity-based service may be received. The request for the identity-based service may be received/associated with a request from a user device (e.g., a mobile device, a smart device, a computer/computing device, a client device, etc.) to connect to a network (e.g., Wi-Fi network, Internet, a private network, a public network, a content delivery network, cellular network, etc.) with a random identifier (e.g., a random MAC address, a random IMSI, a random IMEI, etc.) of the user device. A network device (e.g., an access point, a gateway, a Wi-Fi server, etc.) may receive the request to connect to the network, for example, based on a successful authentication, association, and hand-shake communication process/protocol (e.g., a DHCP handshake, etc.) between the user device and the network device.

For example, a network address (e.g., an IP address, etc.) may be received. The network address may be received by a user device (e.g., a mobile device, a smart device, a computer/computing device, a client device, etc.). The network address may be received by the user device based on a request to connect to a network (e.g., Wi-Fi network, Internet, a private network, a public network, a content delivery network, cellular network, etc.) using a random identifier (e.g., a random MAC address, a random IMSI, a random IMEI, etc.) of the user device. A network device (e.g., an access point, a gateway, a Wi-Fi server, etc.) may send the network address to the user device based on the request to connect to the network. The network address may be sent to the user device based on a successful authentication, association, and hand-shake communication process/protocol (e.g., a DHCP handshake, etc.) between the user device and the network device.

At 1020, the random identifier may be sent to the network device. The user device may use the network address to send the random identifier to the network device. The network device may determine that the random identifier is associated with a persistent identifier (e.g., a MAC address, a IMSI, a IMEI, etc.) of the user device. For example, the network device may determine that an indication of the random identifier is stored, for example within a database, with an indication of the persistent identifier.

At 1030, the user device may connect to the network. The user device may connect to the network using the random identifier. The network device may enable the user device to connect to the network. For example, the user device may send/receive physical layer and/or data layer data/information to/from the network using the random identifier.

At 1040, the at least one identity-based service may be received. The user device may receive, based on the association between the random identifier and the persistent identifier, the at least one identity-based service associated with the user device. For example, based on the association between the random identifier and the persistent identifier, the network device may enable the user device to connect to a local network associated with the persistent identifier and/or the user device via the network. The user device may be enabled to access one or more content items, resources, and/or the like associated with the persistent identifier. The user device, based on the persistent identifier, may be restricted (e.g., via one or more parental control, etc.) from accessing one or more resources/files, websites, and/or the like via the network. The user device may associate, access, engage, and/or participate with any type of identity-based service based on the persistent identifier.

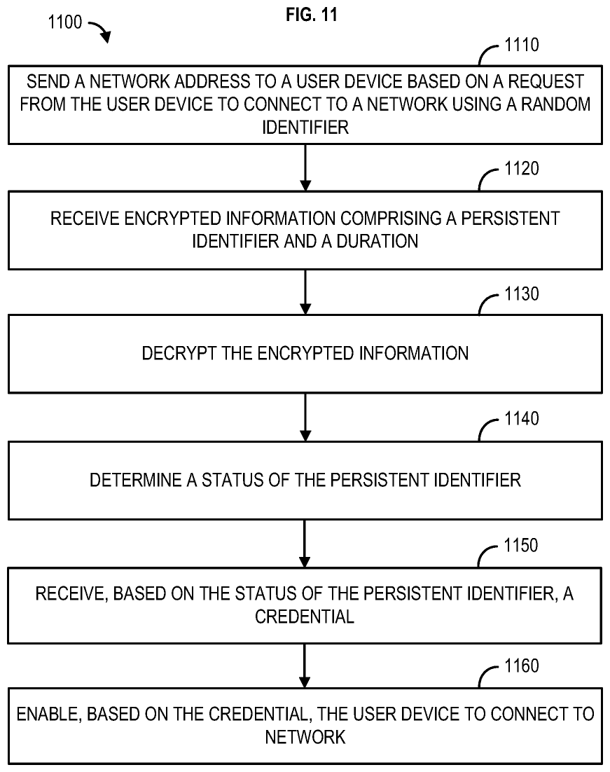

FIG. 11 shows a flowchart of an example method 1100 for enabling identity-based services using a random identifier. At 1110, a network address (e.g., an IP address, etc.) may be sent to a user device (e.g., a mobile device, a smart device, a computer/computing device, a client device, etc.). A network device (e.g., an access point, a gateway, a Wi-Fi server, etc.) may send the network address to the user device based on a request from the user device to connect to a network (e.g., Wi-Fi network, Internet, a private network, a public network, a content delivery network, cellular network, etc.) using a random identifier (e.g., a random MAC address, a random IMSI, a random IMEI, etc.) of the user device. The network address may be sent to the user device based on successful authentication, association, and hand-shake communication process/protocol (e.g., a DHCP handshake, etc.) between the user device and the network device.

At 1120, encrypted information may be received. The network device may receive the encrypted information from the user device based on the network address. For example, the user device may use the network address to send/communicate the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, an IMSI, an IMEI, etc.) of the user device. The user device may use the network address to send encrypted information to the network device. For example, the encrypted information may be sent via one or more of HTTPS, EAP-TLS, SSL, WPA, WPA2, WPA3, WEP, combinations thereof, and/or the like.

At 1130, the encrypted information may be decrypted. To decrypt the encrypted information, the network device may route/send the encrypted information to a captive portal device. The captive portal device may decrypt the encrypted information, for example, using the one or more cryptographic keys (e.g., public keys, a public/private key pair, etc.). The captive portal device may determine the persistent identifier from the decrypted information.

At 1140, a status of the persistent identifier may be determined. The captive portal device may determine the status of the persistent identifier. The captive portal device may determine that the persistent identifier is not associated with a plurality of user devices authorized to access/connect to the network. For example, the captive portal device may determine that the persistent identifier is not associated with a whitelist of user devices authorized to access/connect to the network.

At 1150, a credential may be received. A credential (e.g., an authentication credential, etc.) may include at least one of: login information, password information, an access code, or a response to a challenge query. The captive portal device, based on determining that the persistent identifier is not associated with the plurality of user devices authorized to access/connect to the network, may request at least one credentials from the user device. For example, the captive portal device may generate a login element and/or the like, that includes a graphical user interface that is configured to accept the credential from the user device and/or a user of the user device. The captive portal device may send a request for the credential, for example via the login element, to the network device and the network device may route the request to the user device. The user device may provide, for example via the login element, the credential. The network device may send the credential to the captive portal device.

At 1160, the user device may be enabled to connect to the network. The captive portal device, based on receiving the credential, may associate the persistent identifier with the plurality of user devices authorized to access the network. For example, the captive portal device may associate the persistent identifier with the whitelist of user devices authorized to access/connect to the network. The captive portal device may send an indication of the association between the persistent identifier and the whitelist to the network device. The network device, based on the indication of the association between the persistent identifier and the whitelist, may establish (and/or enable to be established) a connection and/or communication session between the user device and the network.

The connection and/or communication session between the user device and the network enables the user device to receive (e.g., associate with, access, engage, participate with, etc.) one or more identity-based services, such as a login-less network connection and/or reconnection, one or more subscription services, parental controls, content/advertisement tracking, private network access (e.g., identifier-based routing to private SSIDs, etc.), and/or the like.

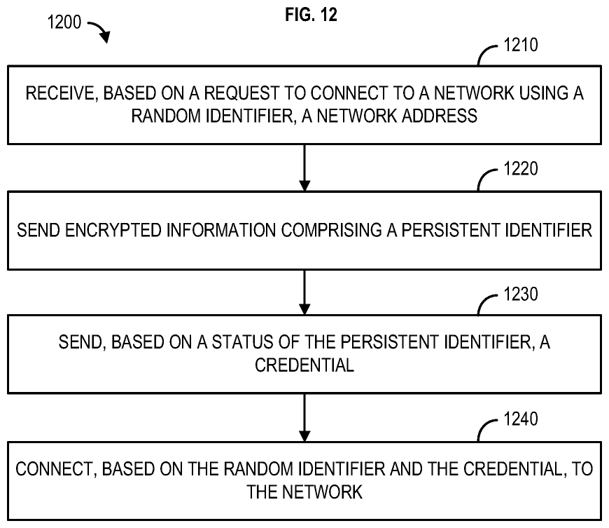

FIG. 12 shows a flowchart of an example method 1200 for enabling identity-based services using a random identifier. At 1210, a network address (e.g., an IP address, etc.) may be received by a user device (e.g., a mobile device, a smart device, a computer/computing device, a client device, etc.). A network device (e.g., an access point, a gateway, a Wi-Fi server, etc.) may send the network address to the user device based on a request from the user device to connect to a network (e.g., Wi-Fi network, Internet, a private network, a public network, a content delivery network, cellular network, etc.) using a random identifier (e.g., a random MAC address, a random IMSI, a random IMEI, etc.) of the user device. The network address may be sent to the user device based on successful authentication, association, and hand-shake communication process/protocol (e.g., a DHCP handshake, etc.) between the user device and the network device.

At 1220, encrypted information may be sent. The user device may use the network address to send the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, an IMSI, an IMEI, etc.) of the user device. The user device may use the network address to send encrypted information to the network device. For example, the encrypted information may be sent via one or more of HTTPS, EAP-TLS, SSL, WPA, WPA2, WPA3, WEP, combinations thereof, and/or the like.

The encrypted information may be decrypted. To decrypt the encrypted information, the network device may route/send the encrypted information to a captive portal device. The captive portal device may decrypt the encrypted information, for example, using the one or more cryptographic keys (e.g., public keys, a public/private key pair, etc.). The captive portal device may determine the persistent identifier from the decrypted information.

At 1230, a credential may be sent. A credential (e.g., an authentication credential, etc.) may include at least one of: login information, password information, an access code, or a response to a challenge query. The user device may send the credential based on the status of the persistent identifier. The captive portal device may determine the status of the persistent identifier. For example, the captive portal device may determine that the persistent identifier is not associated with a plurality of user devices authorized to access/connect to the network. For example, the captive portal device may determine that the persistent identifier is not associated with a whitelist of user devices authorized to access/connect to the network.

The captive portal device, based on determining that the persistent identifier is not associated with the plurality of user devices authorized to access/connect to the network, may request at least one credentials from the user device. For example, the captive portal device may generate a login element and/or the like, that includes a graphical user interface that is configured to accept the credential from the user device and/or a user of the user device. The captive portal device may send a request for the credential, for example via the login element, to the network device and the network device may route the request to the user device. The user device may provide, for example via the login element, the credential. The network device may send the credential to the captive portal device.

At 1240, the user device may connect to the network. The user device may connect to the network based on the random identifier and the credential. The captive portal device, based on receiving the credential, may associate the persistent identifier with the plurality of user devices authorized to access the network. For example, the captive portal device may associate the persistent identifier with the whitelist of user devices authorized to access/connect to the network. The captive portal device may send an indication of the association between the persistent identifier and the whitelist to the network device. The network device, based on the indication of the association between the persistent identifier and the whitelist, may establish (and/or enable to be established) a connection and/or communication session between the user device and the network.

The connection and/or communication session between the user device and the network enables the user device to receive (e.g., associate with, access, engage, participate with, etc.) one or more identity-based services, such as a login-less network connection and/or reconnection, one or more subscription services, parental controls, content/advertisement tracking, private network access (e.g., identifier-based routing to private SSIDs, etc.), and/or the like.

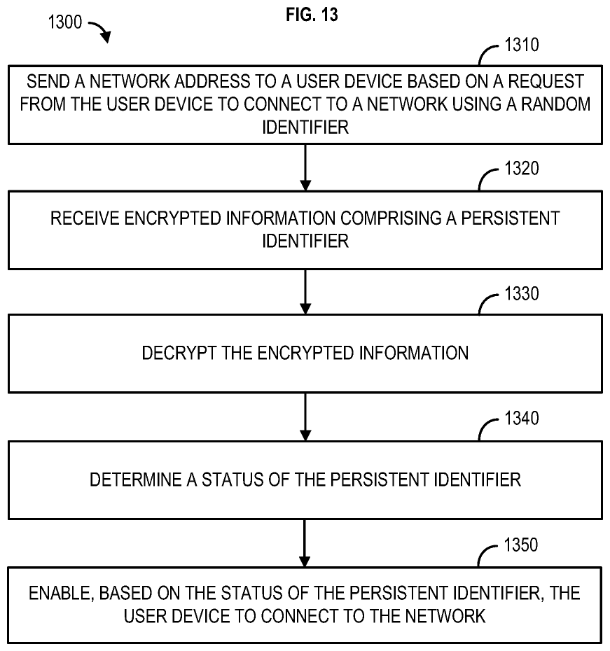

FIG. 13 shows a flowchart of an example method 1300 for enabling identity-based services using a random identifier. At 1310, a network address (e.g., an IP address, etc.) may be sent to a user device (e.g., a mobile device, a smart device, a computer/computing device, a client device, etc.). A network device (e.g., an access point, a gateway, a Wi-Fi server, etc.) may send the network address to the user device based on a request from the user device to connect to a network (e.g., Wi-Fi network, Internet, a private network, a public network, a content delivery network, cellular network, etc.) using a random identifier (e.g., a random MAC address, a random IMSI, a random IMEI, etc.) of the user device. The network address may be sent to the user device based on successful authentication, association, and hand-shake communication process/protocol (e.g., a DHCP handshake, etc.) between the user device and the network device.

At 1320, encrypted information may be received. The network device may receive the encrypted information from the user device based on the network address. For example, the user device may use the network address to send/communicate the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, an IMSI, an IMEI, etc.) of the user device. The user device may use the network address to send encrypted information to the network device. For example, the encrypted information may be sent via one or more of: HTTPS, EAP-TLS, SSL, WPA, WPA2, WPA3, WEP, combinations thereof and/or the like.

At 1230, the encrypted information may be decrypted. To decrypt the encrypted information, the network device may route/send the encrypted information to a captive portal device. The captive portal device may decrypt the encrypted information, for example, using the one or more cryptographic keys (e.g., public keys, a public/private key pair, etc.). The captive portal device may determine the persistent identifier from the decrypted information.

At 1340, a status of the persistent identifier may be determined. The captive portal device may determine the status of the persistent identifier. The captive portal device may determine that the persistent identifier is associated with a plurality of user devices authorized to access/connect to the network. For example, the captive portal device may determine that the persistent identifier is associated with a whitelist of user devices authorized to access/connect to the network.

At 1350, the user device may be enabled to connect to the network. The captive portal device, based on the status of the persistent identifier, may send an indication of the association between the persistent identifier and the whitelist to the network device. The network device, based on the indication of the association between the persistent identifier and the whitelist, may establish (and/or enable to be established) a connection and/or communication session between the user device and the network.

The connection and/or communication session between the user device and the network enables the user device to receive (e.g., associate with, access, engage, participate with, etc.) one or more identity-based services, such as a login-less network connection and/or reconnection, one or more subscription services, parental controls, content/advertisement tracking, private network access (e.g., identifier-based routing to private SSIDs, etc.), and/or the like.

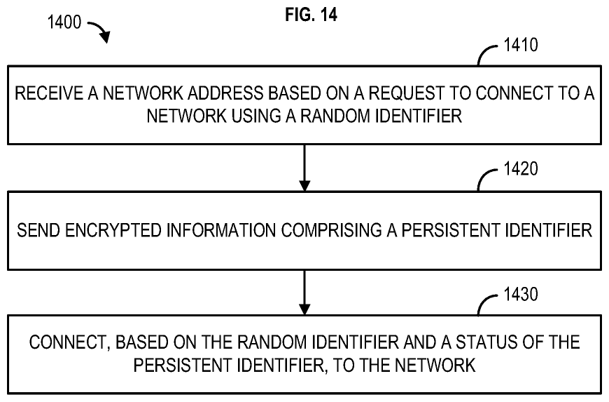

FIG. 14 shows a flowchart of an example method 1400 for enabling identity-based services using a random identifier. At 1410, a network address (e.g., an IP address, etc.) may be received by a user device (e.g., a mobile device, a smart device, a computer/computing device, a client device, etc.). A network device (e.g., an access point, a gateway, a Wi-Fi server, etc.) may send the network address to the user device based on a request from the user device to connect to a network (e.g., Wi-Fi network, Internet, a private network, a public network, a content delivery network, cellular network, etc.) using a random identifier (e.g., a random MAC address, a random IMSI, a random IMEI, etc.) of the user device. The network address may be sent to the user device based on a successful authentication, association, and hand-shake communication process/protocol (e.g., a DHCP handshake, etc.) between the user device and the network device.

At 1420, encrypted information may be sent. The user device may use the network address to send the encrypted information to the network device. The network device, based on the request from the user device to connect to the network, may request a public certificate and/or a resource locator (e.g., URL, etc.) for the public certificate from a certificate issuing entity/authority. The network device may send the public certificate and/or the resource locator for the public certificate to the user device. The public certificate may include and/or be associated with one or more cryptographic keys (e.g., public keys, a public/private key pair, etc.) that may be used to encrypt/decrypt data/information associated with the public certificate.

The user device may use the one or more cryptographic keys and the public certificate to generate encrypted metadata that includes a persistent identifier (e.g., a MAC address, an IMSI, an IMEI, etc.) of the user device. The user device may use the network address to send encrypted information to the network device. For example, the encrypted information may be sent via one or more of HTTPS, EAP-TLS, SSL, WPA, WPA2, WPA3, WEP, combinations thereof, and/or the like.

The encrypted information may be decrypted. To decrypt the encrypted information, the network device may route/send the encrypted information to a captive portal device. The captive portal device may decrypt the encrypted information, for example, using the one or more cryptographic keys (e.g., public keys, a public/private key pair, etc.). The captive portal device may determine the persistent identifier from the decrypted information. The captive portal device may determine that the persistent identifier is associated with a plurality of user devices authorized to access/connect to the network. For example, the captive portal device may determine that the persistent identifier is associated with a whitelist of user devices authorized to access/connect to the network.

At 1430, the user device may connect to the network. The user device may connect to the network based on the random identifier and the credential. The captive portal device, based on the status of the persistent identifier, may send an indication of the association between the persistent identifier and the whitelist to the network device. The network device, based on the indication of the association between the persistent identifier and the whitelist, may establish (and/or enable to be established) a connection and/or communication session between the user device and the network.

The connection and/or communication session between the user device and the network enables the user device to receive (e.g., associate with, access, engage, participate with, etc.) one or more identity-based services, such as a login-less network connection and/or reconnection, one or more subscription services, parental controls, content/advertisement tracking, private network access (e.g., identifier-based routing to private SSIDs, etc.), and/or the like.

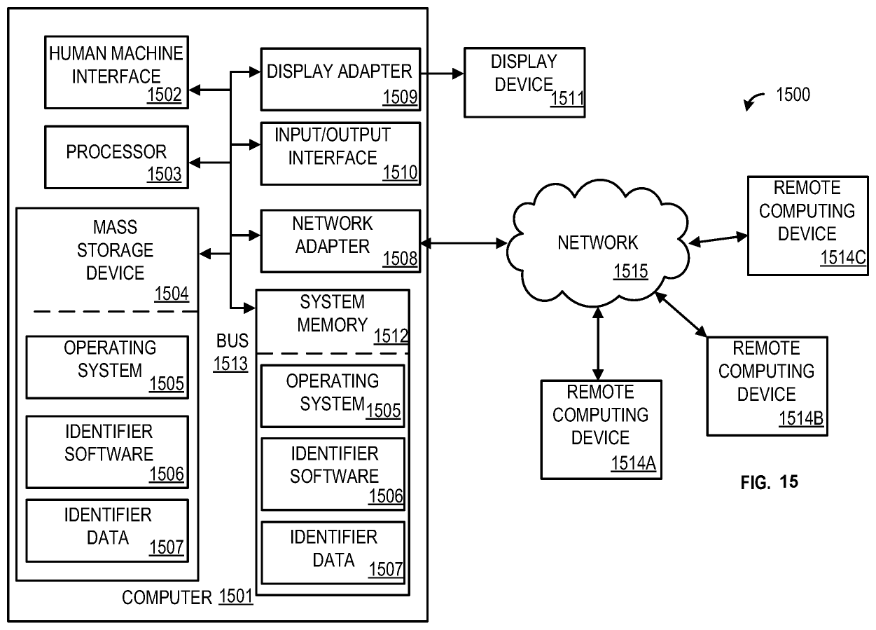

FIG. 15 shows a system 1500 for enabling identity-based services using a random identifier. Any device and/or component described herein may be a computer 1501 as shown in FIG. 15.

The computer 1501 may comprise one or more processors 1503, a system memory 1512, and a bus 1513 that couples various components of the computer 1501 including the one or more processors 1503 to the system memory 1512. In the case of multiple processors 1503, the computer 1501 may utilize parallel computing.

The bus 1513 may comprise one or more of several possible types of bus structures, such as a memory bus, memory controller, a peripheral bus, an accelerated graphics port, and a processor or local bus using any of a variety of bus architectures.

The computer 1501 may operate on and/or comprise a variety of computer-readable media (e.g., non-transitory). Computer-readable media may be any available media that is accessible by the computer 1501 and comprises, non-transitory, volatile and/or non-volatile media, removable and non-removable media. The system memory 1512 has computer-readable media in the form of volatile memory, such as random access memory (RAM), and/or non-volatile memory, such as read-only memory (ROM). The system memory 1512 may store data such as identifier data 1507 and/or program modules such as operating system 1505 and identifier management software 1506 that are accessible to and/or are operated on by the one or more processors 1503.

The computer 1501 may also comprise other removable/non-removable, volatile/non-volatile computer storage media. The mass storage device 1504 may provide non-volatile storage of computer code, computer-readable instructions, data structures, program modules, and other data for the computer 1501. The mass storage device 1504 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1504. An operating system 1505 and identifier management software 1506 may be stored on the mass storage device 1504. One or more of the operating system 1505 and the identifier management software 1506 (or some combination thereof) may comprise program modules and the identifier management software 1506. Identifier data 1507 may also be stored on the mass storage device 1504. Identifier data 1507 may be stored in any of one or more databases known in the art. The databases may be centralized or distributed across multiple locations within the network 1515.

A user may enter commands and information into the computer 1501 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1503 via a human-machine interface 1502 that is coupled to the bus 1513, but may be connected by other interface and bus structures, such as a parallel port, game port, an IEEE 1394 Port (also known as a Firewire port), a serial port, network adapter 1508, and/or a universal serial bus (USB).

A display device 1511 may also be connected to the bus 1513 via an interface, such as a display adapter 1509. It is contemplated that the computer 1501 may have more than one display adapter 1509 and the computer 1501 may have more than one display device 1511. A display device 1511 may be a monitor, an LCD (Liquid Crystal Display), light-emitting diode (LED) display, television, smart lens, smart glass, and/or a projector. In addition to the display device 1511, other output peripheral devices may comprise components such as speakers (not shown) and a printer (not shown) which may be connected to the computer 1501 via Input/Output Interface 1510. Any step and/or result of the methods may be output (or caused to be output) in any form to an output device. Such output may be any form of visual representation, including, but not limited to, textual, graphical, animation, audio, tactile, and the like. The display 1511 and computer 1501 may be part of one device, or separate devices.

The computer 1501 may operate in a networked environment using logical connections to one or more remote computing devices 1514a,b,c. A remote computing device 1514a,b,c may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, a Wi-Fi server, a router, a network computer, a peer device, edge device or other common network nodes, and so on. Logical connections between the computer 1501 and a remote computing device 1514a,b,c may be made via a network 1515, such as a local area network (LAN) and/or a general wide area network (WAN). Such network connections may be through a network adapter 1508. A network adapter 1508 may be implemented in both wired and wireless environments. Such networking environments are conventional and commonplace in dwellings, offices, enterprise-wide computer networks, intranets, and the Internet.

Application programs and other executable program components such as the operating system 1505 are shown herein as discrete blocks, although it is recognized that such programs and components may reside at various times in different storage components of the computer 1501, and are executed by the one or more processors 1503 of the computer 1501. An implementation of the identifier management software 1506 may be stored on or sent across some form of computer readable media. Any of the disclosed methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

t will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
sending, to a user device, based on a request from the user device to connect to a network using a random identifier, a network address;
receiving, based on the network address, encrypted information, wherein the encrypted information comprises a persistent identifier associated with the user device;
determining, based on the encrypted information, the persistent identifier associated with the user device; and
causing, based on the random identifier and the persistent identifier, the user device to connect to the network.

2. The method of claim 1, further comprising causing, based on the persistent identifier being sent to a service associated with the user device, the user device to access to the service.

3. The method of claim 2, wherein the service comprises at least one of: a subscription service, a parental control service, an information tracking service, a private network service, and an auto-login service.

4. The method of claim 1, wherein the user device comprises at least one of: a mobile device, a smart device, or a content player.

5. The method of claim 1, wherein the random identifier comprises at least on of: a random Media Access Control (MAC) address, a random International Mobile Subscriber Identity (IMSI), and a random International Mobile Station Equipment Identity (IMEI).

6. The method of claim 1, wherein the persistent identifier comprises at least on of: a Media Access Control (MAC) address, an International Mobile Subscriber Identity (IMSI), and an International Mobile Station Equipment Identity (IMEI).

7. The method of claim 1, wherein receiving the encrypted information comprises receiving the encrypted information via at least one of: Hypertext Transfer Protocol Secure (HTTPS), Extensible Authentication Protocol-Transport Layer Security (EAP-TLS), and a version of Wi-Fi Protected Access (WPA).

8. The method of claim 1, wherein causing the user device to connect to the network comprises:
decrypting the encrypted information;
determining an association between the random identifier and the persistent identifier; and
granting, based on the association between the random identifier and the persistent identifier, network access to the user device.

9. A method comprising:
receiving, by a user device, based on a request to connect to a network using a random identifier of the user device, a network address;
sending to a network device, based on the network address, encrypted information, wherein the encrypted information comprises a persistent identifier of the user device, wherein the network device is configured to decrypt the encrypted information; and
connecting, based on the random identifier, to the network.

10. The method of claim 9, further comprising sending to a service associated with the user device, the persistent identifier.

11. The method of claim 9, wherein the user device comprises at least one of: a mobile device, a smart device, and a content player.

12. The method of claim 9, wherein the random identifier comprises at least on of: a random Media Access Control (MAC) address, a random International Mobile Subscriber Identity (IMSI), and a random International Mobile Station Equipment Identity (IMEI).

13. The method of claim 9, wherein the network device comprises at least one of: an access point and a gateway device.

14. The method of claim 9, wherein the persistent identifier comprises at least on of: a Media Access Control (MAC) address, an International Mobile Subscriber Identity (IMSI), and an International Mobile Station Equipment Identity (IMEI).

15. The method of claim 9, wherein the encrypted information further comprises public key information, wherein the network device is configured to decrypt the encrypted information based on the public key information.

16. The method of claim 10, wherein sending the persistent identifier causes the user device to have access to the service.

17. The method of claim 10, wherein the service comprises at least one of: a subscription service, a parental control service, an information tracking service, a private network service, and an auto-login service.

18. A method comprising:
receiving, by a network device, a request from a user device to connect to a service associated with the user device, wherein the request comprises a random identifier of the user device;
determining that the random identifier is associated with a persistent identifier of the user device; and
causing, based on the persistent identifier being sent to the service, the user device to have access to the service.

19. The method of claim 18, wherein the user device comprises at least one of: a mobile device, a smart device, and a content player.

20. The method of claim 18, wherein the random identifier comprises at least one of: a random Media Access Control (MAC) address, a random International Mobile Subscriber Identity (IMSI), and a random International Mobile Station Equipment Identity (IMEI).

21. The method of claim 18, wherein the persistent identifier comprises at least one of: a Media Access Control (MAC) address, an International Mobile Subscriber Identity (IMSI), and an International Mobile Station Equipment Identity (IMEI).

22. The method of claim 18, wherein determining that the random identifier is associated with the persistent identifier comprises determining:
sending, to a database, a query comprising the random identifier; and
determining, based on the query, that the random identifier is associated with the persistent identifier.

23. The method of claim 18, wherein the service comprises at least one of: a subscription service, a parental control service, an information tracking service, a private network service, and an auto-login service.
